(19) United States
(12) Patent Application Publication
(10) Pub. No.: US 2004/0196001 A1
(43) Pub. Date: Oct. 7, 2004

(54) Battery for use in a message communication interface assembly

(76) Inventors: Oh-Hyung Kwon, Seoul (KR); Ju-Hyun Lee, Kyungki-do (KR)

Correspondence Address: CONLEY ROSE, P.C., P. O. BOX 3267, HOUSTON, TX, 77253-3267, US

(21) Appl. No.: 10/480,679

(22) PCT Filed: Mar. 4, 2002
(86) PCT No.: PCT/KR02/00366

(30) Foreign Application Priority Data
Jun. 13, 2001 (KR) 2001/0017586
Jun. 21, 2001 (KR) 2001/0035310

(51) Int. Cl. H02J 7/00

(52) U.S. Cl. 320/112

(57) ABSTRACT

Disclosed is an MCIA (message communication interface assembly) battery, easily installable in the MCIA, for realizing lightness, slimness, and overall compactness of the PDA. The MCIA battery comprises a battery body (13) for supplying power; a combiner (9) attachably and removably combined with the slot-type MCIA (3) attachable to/removable from the PDA 1; and hinges (19 and 21) and a link (17) for connecting the battery body (13) with the combiner (9). The hinges and the link rotate the battery body and the combiner to closely attach the battery body to the PDA, and accordingly, the present invention provides an easy installation of the battery in the slot-type MCIA and fully realizes lightness, slimness, and overall compactness that the PDA pursues.

### BACKGROUND OF THE INVENTION

(a) Field of the Invention

The present invention relates to an MCIA (message communication interface assembly) battery. More specifically, the present invention relates to an MCIA battery having a hinge-type installer of a battery for supplying auxiliary power to the MCIA used for a PDA (personal digital assistant).

(b) Description of the Related Art

In general, a PDA, a much smaller computer than a notebook computer, has more powerful computing performance than an electronic pocketbook, and it provides an Internet access service because of recent developments of wireless communication.

An MCIA is required so as to execute wireless Internet access using a PDA.

The MCIA allows workers of various fields such as securities, insurance business, motor vehicles, and other sales business to access the Internet anytime, check electronic mail, and transmit/receive various data while they are moving.

One category of MCIAs is a slot-type MCIA. The slot-type MCIA is formed such that the MCIA is inserted and installed into the PDA from one side thereof in a lengthwise direction.

Power consumption is the greatest when a user installs the MCIA in a PDA and uses the wireless Internet service. Therefore, the MCIA requires a separate auxiliary battery for receiving power when it is used in conjunction with the PDA.

However, since the greatest portion of the slot-type MCIA is inserted into the PDA in the lengthwise direction, it is difficult to install an auxiliary battery in the PDA. Hence, if the battery is attached to the MCIA, the size of the MCIA becomes too large (substantially ⅓ the size of the PDA), and accordingly, its competitiveness with respect to design weakens. Further, since an important factor is that positions of the slots on the PDAs are different for respective manufacturers, the auxiliary battery needs to be flexible so that it may be closely attached and installed to the PDA.

To overcome this problem, the Korea utility model publication No. 177,427 discloses an “Easily attachable and removable terminal-type wireless modem.” The wireless modem provides a hinge between a body and an access unit so that the user may freely control installation angles of the modem body on the PDA.

Therefore, the above-noted wireless modem provides a very convenient configuration when installing an auxiliary battery on an angle-adjustable modem, but its configuration is inconsistent with the lightness, slimness, and overall compactness that the PDA pursues.

### SUMMARY OF THE INVENTION

It is an object of the present invention to provide an MCIA battery that is easily attachable to a slot-type MCIA inserted into a PDA, and that is applicable to various positions of slots, for satisfying lightness, slimness, and overall compactness that the PDA pursues.

In one aspect of the present invention, a message communication interface assembly battery comprises: a combiner removably attached and combined with the slot-type MCIA that is removably inserted into a PDA; and a battery body connected to the combiner using a hinge.

The combiner comprises a dovetail combined with the MCIA according to a dovetail insertion.

The combiner and the battery body are connected according to one of a direct connecting configuration using a hinge, and an indirect connecting configuration using an additional link and two hinges.

As described, the present invention provides a single hinge or a link and two hinges between the combiner and the battery body to thereby control the angles between the battery body and the combiner, and closely attach the battery body to the PDA. Therefore, the battery is more easily installed, and the fundamental targets of the PDA, that is, lightness, slimness, and overall compactness may be more fully realized than in the prior art that rotates a radio modem and installs a battery in the rotated radio modem.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 shows a using-state diagram of an MCIA battery according to a preferred embodiment of the present invention;

FIG. 2 shows a perspective view of the MCIA;

FIG. 3 shows a perspective view of a battery;

FIG. 4 shows a cross-sectional view of a battery installer; and

FIG. 5 shows a manipulation-state diagram of installing and uninstalling the battery.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

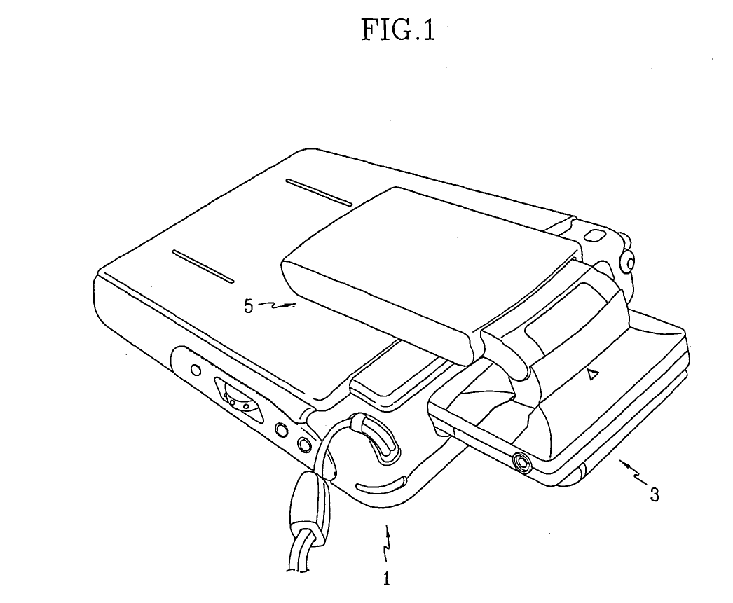

FIG. 1 shows a using-state diagram of an MCIA battery according to a preferred embodiment of the present invention. A battery 5 may be installed in a slot-type MCIA 3 installable into a PDA 1.

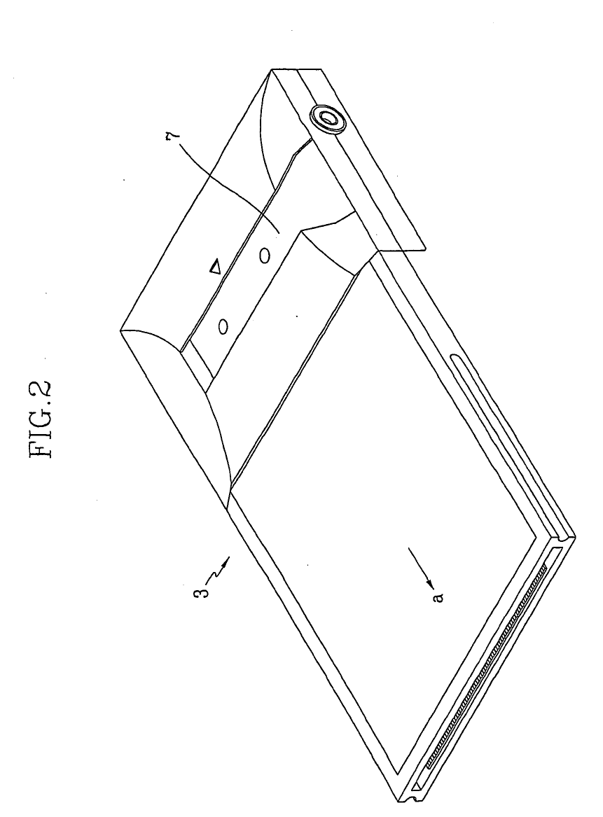

As shown in FIG. 2, the slot-type MCIA 3 is inserted and installed into the PDA 1 from one side thereof in the lengthwise direction “a”. Differing from this, when the slot formed in the PDA 1 is provided in the widthwise direction of the PDA 1, the MCIA 3 may be inserted widthwise. That is, in the case of using an adaptor (not illustrated), the MCIA 3 is formed to be installed in the PDA 1 at any position and in any direction the slot is formed in the PDA 1. Further, when applying the MCIA 3 to a notebook computer (not illustrated), the MCIA 3 may be used without the battery 5.

Also, a dovetail groove 7 for enabling dovetail insertion of the battery 5 is formed on one side of the MCIA 3. The battery 5 slides on the dovetail groove 7 from the right to the left (refer to FIG. 2) by a predetermined distance to be combined with the dovetail groove 7. The dovetail groove 7 has an opened right portion and a closed left portion so that the battery is slid from the left to the right to thereby be detached from the MCIA 3.

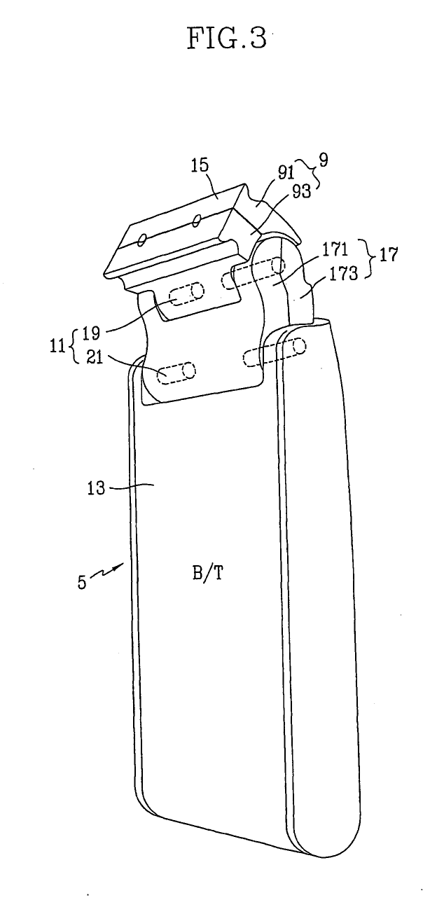

As shown in FIG. 3, the battery 5 that is installed in the dovetail groove 7 comprises a combiner 9 and a battery body 13 connected to the combiner 9 with a hinge 11.

The combiner 9 includes a dovetail 15 to be inserted into the dovetail groove 7 of the MCIA 3.

The hinge 11 for connecting the combiner 9 and the battery body 13 controls the installation angles of the combiner 9 and the battery body 13, the combiner 9 being inserted into the MCIA 3.

Therefore, the single hinge 11 may directly connect the combiner 9 with the battery body 13, and as described in the preferred embodiment, it is more desirable to provide an additional link 17 and connect the combiner 9 and the battery body 13 with the link 17 using the hinges 19 and 21.

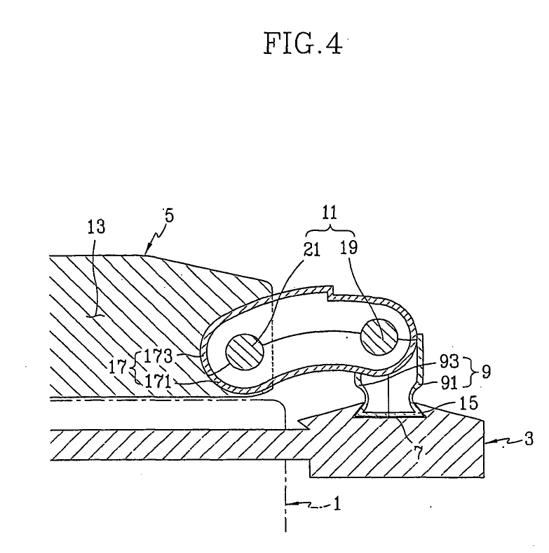

When using the two hinges 19 and 21 and the link 17 as described above, since the battery body 13 may be rotated at the two hinges 19 and 21 together with the link 17 as shown by FIG. 4, the battery body 13 may be more closely attached to the PDA 1 compared to the case of using a single hinge. Namely, the usage of the two hinges 19 and 21 and the link 17 minimizes the increase of the total thickness of the PDA 1 when installing the battery 5 in the PDA 1.

Two pieces 91 and 93 of the combiner 9 facing each other are forcibly connected, and two pieces 171 and 173 of the link 17 facing each other are forcibly connected, and since the forcible connection configuration may be realized through a prior art configuration, no further description and illustration will be provided.

Also, the first hinge 19 is protrusibly formed on both end portions of the yokes of the link 17 to be provided between the two pieces 91 and 93 of the combiner 9, and the second hinge 21 is protrusibly formed on both end portions of the yokes of the battery body 13 to be provided between the two pieces 171 and 173 of the link 17. By respectively providing the hinges 19 and 21 to the link 17 and the battery body 13, the combiner 9 and the battery body 13 are more easily assembled.

Further, the hinges 19 and 21 may be formed to the combiner 9 and the link 17 respectively. In this instance, when the hinges 19 and 21 may be drawn in/out (not illustrated) of the combiner 9 and the link 17 or the battery body 13 may be combined with the link 17, the combiner 9 may be fluently assembled with the battery body 13.

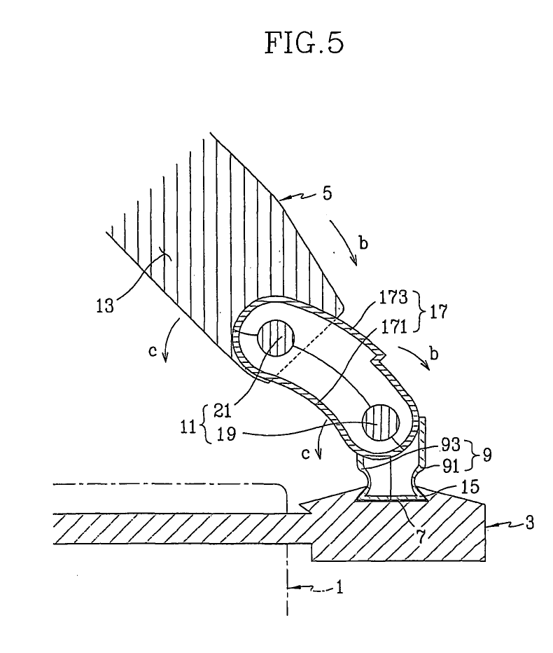

It is desirable to install/uninstall the battery 5 in/from the MCIA 3 according to the state of FIG. 5.

The battery body 13 connected to the combiner 9 through the hinges 19 and 21, and the link 17 is unfolded to an appropriate angle in the “b” direction in parallel with the combiner 9.

Under this state, the dovetail 15 of the combiner 9 is slid into the dovetail groove 7 of the MCIA 3. That is, the combiner 9 is inserted into the MCIA 3.

The battery body 13 is rotated by a predetermined angle in the “c” direction, vertical to that of the combiner 9.

Since the rotated battery body 13 is closely attached to the PDA 1, the case of attaching the battery 5 to the PDA 1 also minimizes the increase of the thickness of the PDA 1.

In addition, the battery body 13 is vertically rotated with respect to the combiner 9 as it is unfolded in the “b” direction to be in parallel with the combiner 9.

In this state, the dovetail 15 of the combiner 9 slides along the dovetail groove 17 of the MCIA 3 to be detached from it. The combiner 9 is detached from the MCIA 3.

As described, the present invention connects the battery body to the combiner using either a single hinge or an additional link and two hinges, and inserts a dovetail of the combiner into the dovetail groove formed on the MCIA so that a battery may be easily installed and uninstalled from the slot-type MCIA installed in a PDA, and the present invention satisfies lightness, slimness, and overall compactness of the PDA when compared to the prior art that rotates a radio modem installable in the PDA by attaching the battery body to the PDA and enables installation of the battery in the radio modem. Additionally, the present invention may be applicable to various positions and directions of the slot formed on the PDA.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A message communication interface assembly (MCIA) battery comprising:
a combiner 9 attachably and removably combined to a slot-type MCIA 3 that is attachably and removably inserted into a personal digital assistant (PDA); and
a battery body 13 connected to the combiner 9 using a hinge 11.

2. The MCIA battery of claim 1, wherein the combiner 9 comprises a dovetail 15 combined with the MCIA 3 according to a dovetail insertion.

3. The MCIA battery of claim 1, wherein the combiner 9 and the battery body 13 are connected according to one of a direct-connecting configuration using a hinge, and an indirect-connecting configuration using an additional link 17 and two hinges 19 and 21.
